(19) United States
(12) Patent Application Publication
(10) Pub. No.: US 2017/0211473 A1
(43) Pub. Date: Jul. 27, 2017

(54) GAS TURBINE

(71) Applicant: KAWASAKI JUKOGYO KABUSHIKI KAISHA, Hyogo (JP)

(72) Inventors: Kazuhide HAKAMADA, Akashi-shi (JP); Seiji YAMASHITA, Kobe-shi (JP); Takeo ODA, Kobe-shi (JP)

(73) Assignee: KAWASAKI JUKOGYO KABUSHIKI KAISHA, Hyogo (JP)

(21) Appl. No.: 15/515,113

(22) PCT Filed: Sep. 28, 2015
(86) PCT No.: PCT/JP2015/004909

§ 371 Date: Mar. 28, 2017

(30) Foreign Application Priority Data
Sep. 29, 2014 (JP) 2014-198190

(51) Int. Cl. F02C 3/30; F02C 3/22

(52) U.S. Cl. CPC F02C 3/30; F02C 3/22; F02C 3/305; F02C 7/16

(57) ABSTRACT

A gas turbine (100) of the present invention is a gas turbine which uses a hydrogen gas as a fuel, and comprises a combustor (20) which includes a fuel injection nozzle (23), and has a combustion chamber (24) in an interior of the combustor; a steam supply unit (40) which supplies steam to the combustor (20) to decrease a combustion temperature; and an air drier (50) which removes the steam from air to be supplied to the combustor (20) to dry the air.

### TECHNICAL FIELD

The present invention relates to a gas turbine which uses a hydrogen gas as a fuel.

### BACKGROUND ART

A gas turbine which uses a hydrogen gas as a fuel has an advantage that carbon dioxide or carbon monoxide resulting from combustion is not discharged and an exhaust gas is clean. (see Patent Literature 1).

### CITATION LIST

### Patent Literature

Patent Literature 1: Japanese Translation of PCT Application Publication No. 2010-535303

### SUMMARY OF INVENTION

### Technical Problem

In the gas turbine which uses the hydrogen gas as the fuel, water is generated through a chemical reaction by combustion. Therefore, if water (steam) for suppressing the discharge amount of NOx is supplied to a combustor (burner), then the exhaust gas will contain plenty of steam. In this case, if the exhaust gas of the gas turbine is supplied to a boiler for steam turbine power generation to utilize waste heat, then degradation of the heat transmission capability of the boiler or corrosion of the boiler may occur due to the steam.

In order to suppress occurrence of the degradation of the heat transmission capability of the boiler or the corrosion of the boiler, it is necessary to adjust the amount of the steam in the interior of a combustion chamber, namely, a sum (hereinafter this will also be referred to as “total steam amount”) of the amount of the steam to be supplied to the combustor to reduce the discharge amount of NOx and the amount of the steam contained in the air to be supplied to the combustor. In addition to the above-described problem associated with the boiler, the following problem may arise. In a case where the amount of the steam in the interior of the combustion chamber is extremely small, it is difficult to lower a combustion temperature sufficiently, and as a result, the generation amount of NOx is increased. On the other hand, in a case where the amount of the steam in the interior of the combustion chamber is excessively large, combustion efficiency is reduced.

Of the amount of the steam (total steam amount) in the interior of the combustion chamber, the amount of the steam contained in the air to be supplied to the combustor is varied depending on season or climate (weather). It is not easy to measure the amount of the steam contained in the air. As a matter of course, it is not easy to adjust the amount of the steam in the interior of the combustion chamber.

In view of the above-described circumstances, the present invention has been developed. An object of the present invention is to precisely control the amount of the steam in the interior of the combustion chamber, in the gas turbine to which the hydrogen gas is supplied as the fuel.

### Solution to Problem

A gas turbine which uses a hydrogen gas as a fuel, according to an aspect of the present invention, comprises a combustor which includes a fuel injection nozzle, and has a combustion chamber in an interior of the combustor; a steam supply unit which supplies steam to the combustor to decrease a combustion temperature; and an air drier which removes the steam from air to be supplied to the combustor to dry the air.

In accordance with this configuration, since the dried air is supplied to the combustor, a total steam amount can be adjusted without considering the amount of the steam contained in the air (in other words, under the assumption that the air to be supplied to the combustor contains no steam). In this way, the total steam amount can be adjusted easily.

In the above turbine, the air drier may include a heat exchange section which takes heat from the air to be supplied to the combustor by heat exchange with the hydrogen gas to cool the air, and condenses the steam contained in the air to remove the steam.

In accordance with this configuration, the hydrogen gas in a low-temperature state can be efficiently used. In addition, it is not necessary to obtain a cold source from an outside area of the gas turbine.

In the above gas turbine, the steam supply unit may include a steam generator which heats water supplied to the steam supply unit to generate the steam to be supplied to the combustor, and at least a part of the water to be supplied to the steam supply unit may be condensed water generated from the air having been cooled by the heat exchange with the hydrogen gas in the heat exchange section.

In accordance with this configuration, the condensed water generated in the heat exchange section can be efficiently used.

### Advantageous Effects of Invention

As described above, in accordance with the above-described gas turbine, the amount of the steam in the interior of the combustion chamber can be precisely controlled.

### BRIEF DESCRIPTION OF DRAWINGS

FIG. 1 is a schematic view showing a gas turbine according to an embodiment.

### DESCRIPTION OF EMBODIMENTS

Hereinafter, the embodiment of the present invention will be described with reference to the drawings. Throughout the drawings, the same or corresponding components are designated by the same reference symbols and will not be described repeatedly.

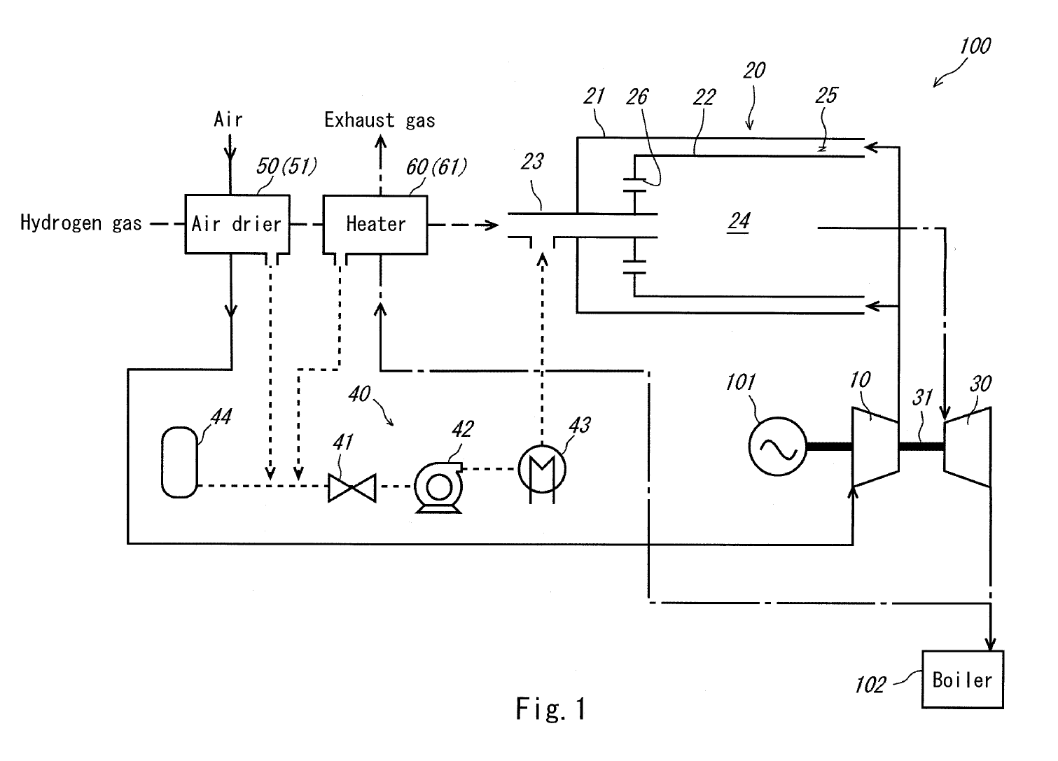

FIG. 1 is a schematic view showing the configuration of a gas turbine 100. In FIG. 1, broken lines indicate a passage of a fuel (hydrogen gas), solid lines indicates a passage of air, one-dotted lines indicate a passage of a combustion gas and an exhaust gas, and dotted lines indicate a passage of water and steam.

The gas turbine 100 of the present embodiment is a gas turbine for power generation which drives a generator 101. Waste heat of the gas turbine 100 is utilized for steam turbine power generation. In other words, the gas turbine 100 is a part of a combined cycle power generation system. The gas turbine 100 of the present embodiment uses the hydrogen gas as the fuel. The hydrogen gas in a low-temperature state is supplied to the gas turbine 100. In the present embodiment, the term “low-temperature” is, for example, a temperature equal to or lower than 0 degree C.

As shown in FIG. 1, the gas turbine 100 includes a compressor 10, a combustor 20, a turbine 30, a steam supply unit 40, an air drier 50, and a heater 60. Hereinafter, these constituents will be sequentially described.

The compressor 10 is configured to compress the air (outside air) which has flowed through the air drier 50 which will be described later, and supply the compressed air to the combustor 20. The generator 101 is connected to the compressor 10. According to the rotation of the compressor 10, the generator 101 rotates and thus performs power generation.

The combustor 20 includes a housing 21, a liner 22, and a fuel injection nozzle 23. Although the combustor 20 of the present embodiment is of a reverse flow can type in which the air and the combustion gas flow in opposite directions, a structure different from the reverse flow can type may be used. The housing 21 has a cylindrical shape. The liner 22 is disposed inside the housing 21. The liner 22 also has a cylindrical shape and the combustion chamber 24 is formed inside the liner 22. The fuel injection nozzle 23 penetrates the housing 21 and the liner 22, and is configured to inject the hydrogen gas into the combustion chamber 24.

An annular air passage 25 is provided between the housing 21 and the liner 22. The air having been compressed in the compressor 10 flows to the left of FIG. 1 through the air passage 25. After flowing through the air passage 25, the air is supplied to the combustion chamber 24 through air holes 26 formed in the liner 22 at locations that are in the vicinity of the fuel injection nozzle 23. In the combustion chamber 24, the hydrogen gas and the air are combusted to generate the combustion gas. The generated combustion gas flows to the right of FIG. 1 in the interior of the combustion chamber 24.

The combustion gas in a high-temperature and high-pressure state which has been generated in the combustor 20 is supplied to the turbine 30. The turbine 30 rotates by energy of the combustion gas. The turbine 30 is connected to the compressor 10 via a coupling shaft 31. According to the rotation of the turbine 30, the compressor 10 rotates. The combustion gas which has flowed through the turbine 30, namely, the exhaust gas, is supplied to the boiler 102 for steam turbine power generation. Also, a part of the exhaust gas is supplied to the heater 60.

The steam supply unit 40 is a unit which supplies the steam to the combustor 20 to decrease the combustion temperature. The steam supply unit 40 includes a flow control valve 41, a water pump 42, and a steam generator 43. The flow control valve 41 is a valve which adjusts the amount of water supplied to the steam supply unit 40. In other words, the flow control valve 41 is capable of adjusting the amount of the steam to be supplied to the combustor 20. The water pump 42 is a pump which is located downstream of the flow control valve 41, and sends the water supplied to the steam supply unit 40 to the steam generator 43. The steam generator 43 is a device which heats the supplied water to generate the steam. A heat source of the steam generator 43 is not particularly limited, and the exhaust gas discharged from the gas turbine 100 may be used as the heat source.

The steam supply unit 40 of the present embodiment supplies the generated steam to the fuel injection nozzle 23. The steam is supplied to the combustion chamber 24 via the fuel injection nozzle 23. This allows a mixture of the steam and the hydrogen gas to be supplied to the combustion chamber 24. Since the steam is mixed with the hydrogen gas before the steam is supplied to the combustion chamber 24, a combustion area in which the combustion is performed in the combustion chamber 24 conforms to an area of the combustion chamber 24 to which the steam is supplied. Therefore, the steam is distributed in the whole of the combustion area, and generation of NOx can be suppressed effectively. Although in the present embodiment, the steam supply unit 40 directly supplies the steam to the fuel injection nozzle 23, it may supply the steam to a location which is on the passage of the hydrogen gas and is upstream of the fuel injection nozzle 23.

In the present embodiment, the water is supplied from a water supply tank 44, the air drier 50, and the heater 60 to the steam supply unit 40. Among these, the water supplied from the air drier 50 and the water supplied from the heater 60 will be described later. Although in the present embodiment, the water is supplied from all of the water supply tank 44, the air drier 50, and the heater 60 to the steam supply unit 40, the water may be supplied from a part of the water supply tank 44, the air drier 50, and the heater 60 to the steam supply unit 40. For example, the water may be supplied from only the heater 60 to the steam supply unit 40,

The air drier 50 is a device which dries the air to be supplied to the combustor 20. The air drier 50 of the present embodiment is disposed upstream of the compressor 10, on the passage of the air. Therefore, the air drier 50 dries the air (outside air) taken from an outside area and supplies the dried air to the compressor 10. The dried air is compressed in the compressor 10 and then is supplied to the combustor 20. Although in the present embodiment, the dried air is compressed, the compressed air may be dried. To realize this, the air drier 50 may be located downstream of the compressor 10 on the passage of the air. Nonetheless, by drying the air to be supplied to the compressor 10 as described in the present embodiment, a load of the compressor 10 can be reduced.

The air drier 50 of the present embodiment dries the air by use of the hydrogen gas. Specifically, the air drier 50 includes a first heat exchange section 51 which performs heat exchange between the hydrogen gas and the air. For example, the hydrogen gas having a temperature of −20 degrees C. and the air having a normal (room) temperature are supplied to the first heat exchange section 51. The hydrogen gas takes heat from the air to cool the air to 5 degrees C. Thereby, the steam contained in the air is condensed and removed, and the air is dried. Condensed water is generated from the air. In the present embodiment, the condensed water is supplied to the steam supply unit 40. In a case where the air is dried by the heat exchange between the hydrogen gas and the air, the temperature of the hydrogen gas is desirably in a range of −20 degrees C. to 0 degree C. The reason is as follows. If the temperature of the hydrogen gas is lower than −20 degrees C., ices may be formed in a region of the passage of the air, and the passage may be clogged with the ices. In contrast, if the temperature of the hydrogen gas is higher than 0 degree C., the air may be dried insufficiently.

In the gas turbine 100 which uses the hydrogen gas as the fuel, the water is generated through a chemical reaction by the combustion. If the steam is supplied to the combustor 20 to suppress the discharge amount of NOx as described above, then the exhaust gas will contain plenty of steam. For this reason, water droplets are generated in the boiler 102 to which the exhaust gas is supplied, and may cause degradation of the heat transmission capability of the boiler 102 or corrosion of the boiler 102. To avoid this, it is necessary to adjust the total steam amount which is a sum of the amount of the steam to be supplied from the steam supply unit 40 to the combustor 20 and the amount of the steam contained in the air to be supplied to the combustor 20.

However, since it is not easy to measure the amount of the steam contained in the air to be supplied to the combustor 20, it is not easy to adjust the total steam amount, as a matter of course. In view of this, in the present embodiment, the air to be supplied to the combustor 20 is dried as described above. This makes it possible to adjust the total steam amount without considering the amount of the steam contained in the air (in other words, under the assumption that the air to be supplied to the combustor 20 contains no steam). In brief, the total steam amount can be adjusted by controlling only the opening degree of the flow control valve 41 which is determined depending on the operation state of the gas turbine 100. In this way, the total steam amount can be adjusted easily.

The heater 60 is a device which heats the hydrogen gas to be supplied to the fuel injection nozzle 23, and heats the fuel injection nozzle 23 by the heat transferred from the hydrogen gas. The heater 60 is disposed downstream of the air drier 50, on the passage of the hydrogen gas. In this layout, the hydrogen gas flows through the air drier 50 and then flows into the heater 60. The heater 60 of the present embodiment heats the hydrogen gas by use of the exhaust gas. Specifically, the heater 60 includes a second heat exchange section 61 which performs the heat exchange between the hydrogen gas and the exhaust gas. In the second heat exchange section 61, the heat of the exhaust gas is transferred to the hydrogen gas and the hydrogen gas is thereby heated. In this way, the heat of the exhaust gas can be efficiently utilized. In addition, it is not necessary to obtain the heat source of the heater 60 from an outside area of the gas turbine.

In the present embodiment, the hydrogen gas is heated up to a temperature at which the steam supplied from the steam supply unit 40 is not condensed when the steam contacts the hydrogen gas or the fuel injection nozzle 23. Specifically, the hydrogen gas is heated so that the temperature of the hydrogen gas becomes equal to or higher than a supply temperature of the steam supplied from the steam supply unit 40 and equal to or lower than a temperature which is a sum of the supply temperature of the steam and 10 degrees C. (the supply temperature plus 10 degrees C.). For example, in a case where the temperature of the steam supplied from the steam supply unit 40 is 220 degrees C., the heater 60 heats the hydrogen gas so that the temperature of the hydrogen gas becomes equal to or higher than 220 degrees C. and equal to or lower than 230 degrees C. In a case where the heat source is common to the steam generator 43 of the steam supply unit 40 and the heater 60, the temperature of the steam supplied from the steam supply unit 40 and the temperature of the hydrogen gas to be supplied to the fuel injection nozzle 23 can be made equal to each other.

As described above, since the temperature of the hydrogen gas is increased to become equal to or higher than the temperature of the steam supplied from the steam supply unit 40, the steam which contacts the hydrogen gas or the fuel injection nozzle 23 is not condensed. However, if the hydrogen gas is heated excessively, the waste heat of the gas turbine 100 may be used wastefully. In view of this, the temperature of the hydrogen gas is desirably increased to become equal to or lower than the temperature which is a sum of the temperature of the steam supplied from the steam supply unit 40 and 10 degrees C. (temperature of the steam plus 10 degrees C.).

Since the gas turbine 100 of the present embodiment uses the hydrogen gas as the fuel, the water is generated by the combustion of the hydrogen gas, and the exhaust gas contains plenty of steam. For this reason, the condensed water is generated in large amount from the exhaust gas, the temperature of which has been lowered by the heat exchange in the second heat exchange section 61. The condensed water generated in the second heat exchange section 61 is supplied to the steam supply unit 40 as described above. In this way, the condensed water generated in the second heat exchange section 61 can be efficiently used.

In a gas turbine which uses LNG (natural gas) as the fuel, the exhaust gas contains carbon dioxide, carbon monoxide, and others. In contrast, the gas turbine 100 of the present embodiment which uses the hydrogen gas as the fuel, the exhaust gas is almost free from carbon dioxide and carbon monoxide. For this reason, impurities such as carbon dioxide is not substantially dissolved in the condensed water generated in the second heat exchange section 61 of the present embodiment. This condensed water does not negatively affect the combustor 20 even when the condensed water is used as the steam to be supplied to the combustor 20.

In the present embodiment, the first heat exchange section 51 of the air drier 50 and the second heat exchange section 61 of the heater 60 are configured to increase the temperature of the hydrogen gas by the heat exchange. Therefore, it is considered that the location of the air drier 50 and the location of the heater 60 are reversed, and the heater 60 is disposed upstream of the air drier 50, on the passage of the hydrogen gas. However, in this layout, the temperature of the hydrogen gas flowing into the air drier 50 is excessively high (in the above-described example, the temperature of the hydrogen gas is 220 degrees C.), and cannot cool the air (in the above-described example, the temperature of the cooled air is 5 degrees C.). In view of this, the heater 60 is disposed downstream of the air drier 50, on the passage of the hydrogen gas.

Although in the present embodiment, the air drier 50 dries the air by the heat exchange, it may dry the air by a method other than the heat exchange. Likewise, although in the present embodiment, the heater 60 heats the hydrogen gas by the heat exchange, it may heat the hydrogen gas by a method other than the heat exchange.

Thus far, the present embodiment has been described. Although in the above-described embodiment, the steam supply unit 40 supplies the steam to the combustion chamber 24 through the fuel injection nozzle 23, the steam may be supplied to the combustion chamber 24 without flowing through the fuel injection nozzle 23. For example, the steam may be injected into the air to be supplied to the combustion chamber 24 (the water is sprayed), and thus the steam may be supplied to the combustion chamber 24.

### INDUSTRIAL APPLICABILITY

In accordance with the present invention, in the gas turbine which uses the hydrogen gas as the fuel, the amount of the steam in the interior of the combustion chamber can be precisely controlled. Therefore, the present invention is useful in the field of the gas turbine which uses the hydrogen gas as the fuel.

### REFERENCE SIGNS LIST

20 combustor

23 fuel injection nozzle

24 combustion chamber

40 steam supply unit

43 steam generator

50 air drier

51 first heat exchange section (heat exchange section)

100 gas turbine

1. A gas turbine which uses a hydrogen gas as a fuel, the gas turbine comprising:
a combustor which includes a fuel injection nozzle, and has a combustion chamber in an interior of the combustor;
a steam supply unit which supplies steam to the combustor to decrease a combustion temperature; and
an air drier which removes the steam from air to be supplied to the combustor to dry the air.

2. The gas turbine according to claim 1,
wherein the air drier includes a heat exchange section which takes heat from the air to be supplied to the combustor by heat exchange with the hydrogen gas to cool the air, and condenses the steam contained in the air to remove the steam.

3. The gas turbine according to claim 2,
wherein the steam supply unit includes a steam generator which heats water supplied to the steam supply unit to generate the steam to be supplied to the combustor, and
wherein at least a part of the water to be supplied to the steam supply unit is condensed water generated from the air having been cooled by the heat exchange with the hydrogen gas in the heat exchange section.
